(19) United States
(12) Patent Application Publication
(10) Pub. No.: US 2023/0049404 A1
(43) Pub. Date: Feb. 16, 2023

(54) ROTARY TYPE GRIPPING DEVICE FOR ELECTRICAL HEDGE TRIMMER

(71) Applicant: REXON INDUSTRIAL CORPORATION LTD., Taichung City (TW)

(72) Inventors: WAN-JIE YOU, TAICHUNG CITY (TW); YUE-YI LIN, TAICHUNG CITY (TW)

(21) Appl. No.: 17/888,666

(22) Filed: Aug. 16, 2022

(30) Foreign Application Priority Data
Aug. 16, 2021 (TW) 110130170

(51) Int. Cl. B25F 5/02; A01G 3/053

(52) U.S. Cl. CPC B25F 5/02; A01G 3/053

(57) ABSTRACT

A gripping device includes a housing has an annular flange and a plurality of positioning recesses provided at the annular flange, a rear handle assembled with the annular flange of the housing, a push button pivoted to the rear handle and partially exposed to the outsides, a positioning block disposed in the rear handle, and a link rod having two ends pivoted to the push button and the positioning block, respectively. When the push button is unlocked, the positioning block is driven by the link rod to be disengaged from the positioning recesses, such that the rear handle is rotatable to adjust angle. When the push button is locked, the positioning block is engaged with one of the positioning recesses under the force of an elastic member for positioning the rear handle.

Therefore, a user can operate the gripping device at an ergonomic angle.

### BACKGROUND OF THE INVENTION

### 1. Field of the Invention

The present invention relates to an electrical hedge trimmer and more particularly, to a rotary type gripping device for an electrical hedge trimmer.

### 2. Description of the Related Art

In order to allow a user to operate an electrical hedge trimmer stably, the conventional electrical hedge trimmer includes a front handle and a rear handle. The front handle is fixed to serve as a fulcrum. The rear handle is rotatable to different angles for facilitating adjustment of gripping angle. However, the conventional rear handle is not ergonomic in design. This will cause the user fatigue easily under prolonged operation, and therefore the user can't complete a large number of trimming jobs.

### SUMMARY OF THE INVENTION

It is a primary objective of the present invention to provide a rotary type gripping device for an electrical hedge trimmer, which is ergonomic in design for reducing fatigue and increasing comfort.

To attain the above objective, the rotary type gripping device of the present invention comprises a housing, a rear handle, and a positioning unit. The rear end of the housing has an annular flange and a plurality of positioning recesses provided at the annular flange. The rear handle is rotatably disposed to the annular flange of the housing. The positioning unit includes a push button, a positioning block, a link rod, and an elastic member. The push button is pivoted to the rear handle so as to be pivotable relative to the rear handle. The positioning block is disposed in the rear handle and adjacent to the annular flange of the housing. The link rod is disposed in the rear handle, and has one end eccentrically pivoted to the push button and the other end pivoted to the positioning block, such that the link rod is driven by the push button to move the positioning block. The elastic member is disposed in the rear handle and provides an elastic force to push the positioning block towards the annular flange of the housing.

It can be seen from the above that when adjusting the angle of the rear handle, a user pushes the push button to an unlock position where the positioning block is driven by the link rod to be disengaged from the positioning recesses, such that the rear handle is rotatable to adjust angle. Once the rear handle is adjusted to a suitable angle, the user releases the force applied to the push button, such that the positioning block is engaged with one of the positioning recesses by the elastic force of the elastic member for positioning the rear handle. By this way, the rotary type gripping device of the present invention can be operated at an ergonomic angle for achieving effects of reducing fatigue and increasing comfort.

Preferably, the positioning recesses are arranged in an equally-spaced manner relative to the center of the annular flange, such that the rear handle can be positioned at 0 degree, 90 degrees or minus 90 degrees.

Preferably, the push button has a pushed portion exposed to the top surface of the rear handle for facilitating the user to push through the thumb.

Preferably, the outer surface of the annular flange of the housing has two first guiding concavities and a first guiding convexity abutted between the first guiding concavities. The inner surface of the front end of the rear handle has two second guiding convexities and a second guiding concavity abutted between the second guiding convexities. The second guiding convexities of the rear handle are inserted into the first guiding concavities of the annular flange of the housing, and the second guiding concavity of the rear handle is inserted into the first guiding convexity of the annular flange of the housing. By this way, the rear handle is rotated relative to the housing stably.

Preferably, the rear handle has an obstruction wall, and the positioning block has a support portion. The top end of the elastic member is abutted against the obstruction wall of the rear handle and the bottom end of the elastic member is abutted against the support portion of the positioning block, such that the elastic member provides an elastic force to push the positioning block towards the annular flange.

Preferably, a motor switch is provided to the rear handle and located behind the positioning unit. By this way, when the user operates the motor switch through the index finger, the user pushes the push button by using the thumb at the same time, such that the user can operate the rotary type gripping device of the present invention with one hand.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of an electrical hedge trimmer using a rotary type gripping device according to an embodiment of the present invention.

FIG. 2 is an exploded view of the rotary type gripping device according to the embodiment of the present invention.

FIG. 3 is a partially sectional view of the rotary type gripping device according to the embodiment of the present invention, showing that the push button is located at the unlock position.

FIG. 4 is similar to FIG. 3, showing that the push button is located at the lock position.

FIG. 5 is an end view of the rotary type gripping device according to the embodiment of the present invention.

FIG. 6 is similar to FIG. 5, showing that the rear handle is rotated 90 degrees in a clockwise direction.

FIG. 7 is similar to FIG. 5, showing that the rear handle is rotated 90 degrees in a counterclockwise direction.

### DETAILED DESCRIPTION OF THE INVENTION

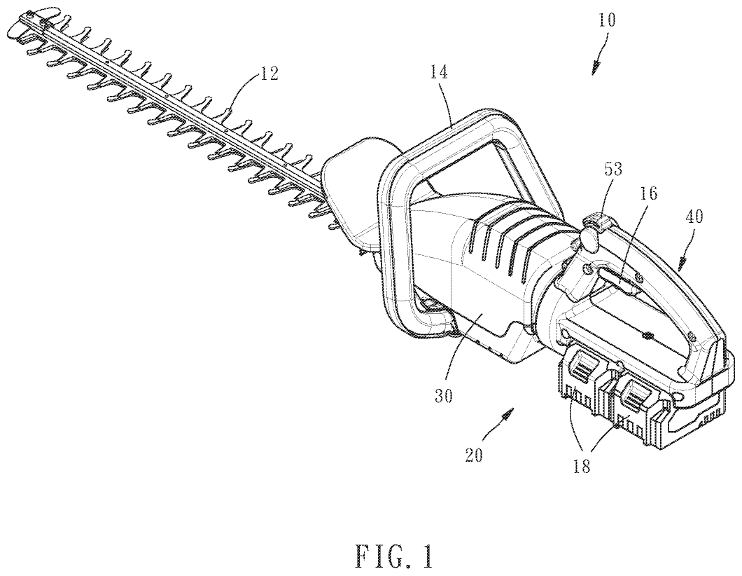

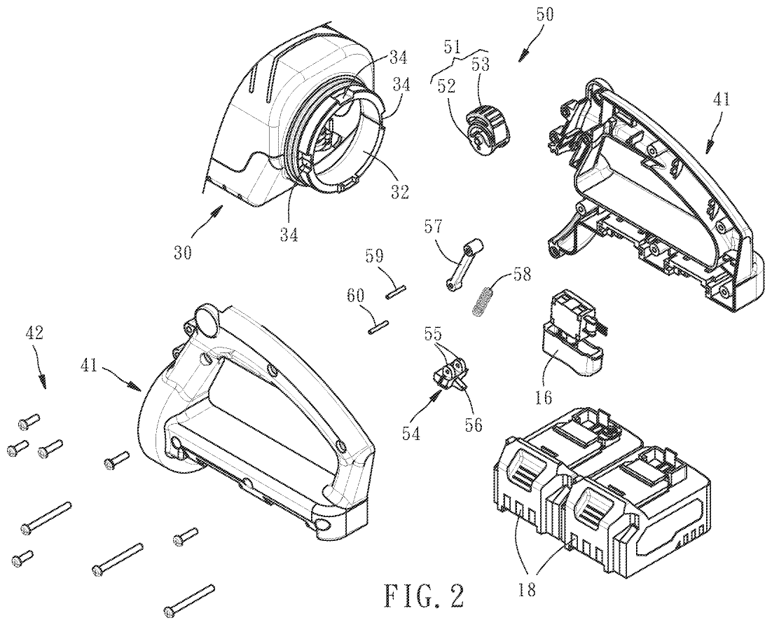

Referring to FIG. 1, a rotary type gripping device 20 of the present invention is applied to an electrical hedge trimmer 10. Because the electrical hedge trimmer 10 is not the key point of the invention, the detailed configuration will not be repeatedly mentioned hereunder. As shown in FIGS. 1 and 2, the rotary type gripping device 20 of the present invention comprises a housing 30, a rear handle 40, and a positioning unit 50.

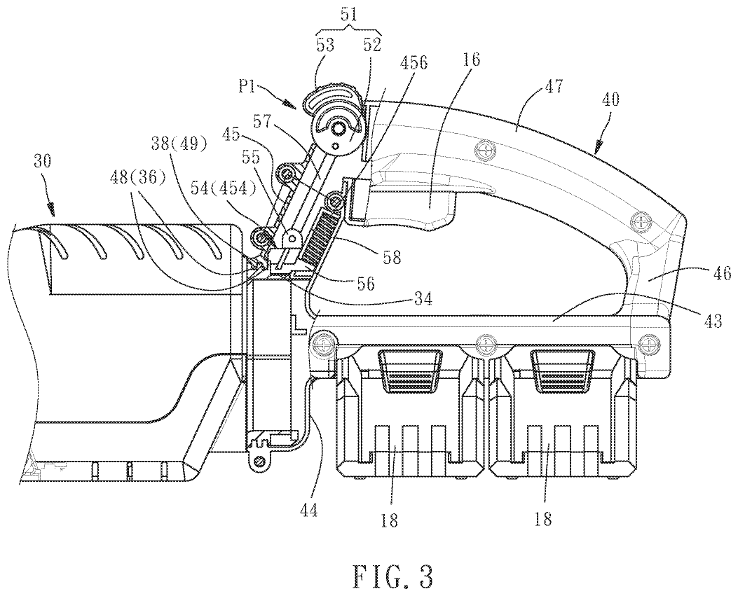

The housing 30 is used for installation of a motor (not shown). The aforesaid motor is connected with blades 12 located in front of the housing 30, such that the blades 12 can be driven by the motor. In addition, a front handle 14 is provided over the top of the housing 30 and has two ends fixed to the two opposite sides of the housing 30. As shown in FIG. 2, the rear end of the housing 30 has an annular flange 32 and three positioning recesses 34 provided at the outer surface of the annular flange 32 and arranged in an equally-spaced manner relative to the center of the annular flange 32. That is to say, the three positioning recesses 34 are spaced at 90 degrees from each other. As shown in FIG. 3, the outer surface of the annular flange 32 has two first guiding concavities 36 and a first guiding convexity 38 abutted between the first guiding concavities 36. The first guiding concavities 36 and the first guiding convexity 38 extend in an annular manner around the annular flange 32.

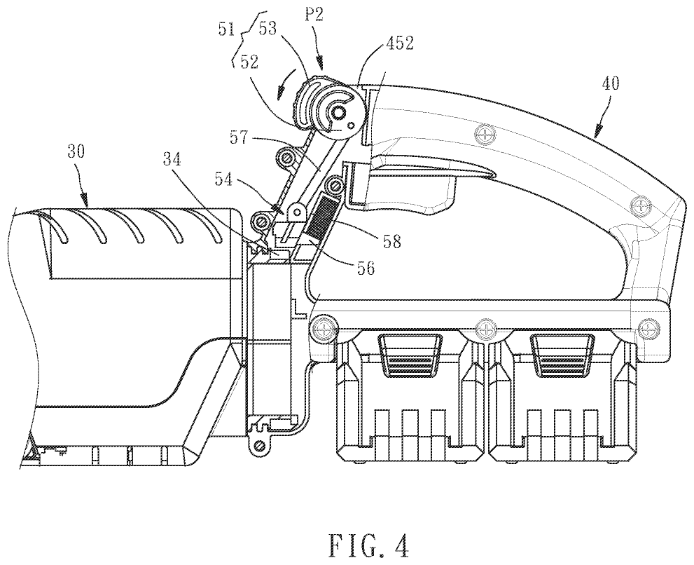

The rear handle 40 is formed by two lateral covers 41 assembled with each other by using a plurality of screws 42. As shown in FIG. 3, the rear handle 40 includes a bottom portion 43, an annular sleeve portion 44, a front connecting portion 45, a rear connecting portion 46, and a gripping portion 47. The annular sleeve portion 44 is integrally connected with the front end of the bottom portion 43, and the inner surface of the annular sleeve portion 44 has two second guiding convexities 48 and a second guiding concavity 49 abutted between the second guiding convexities 48. The second guiding convexities 48 and the second guiding concavity 49 extend in an annular manner around the annular sleeve portion 44. As shown in FIGS. 3 and 4, the bottom end of the front connecting portion 45 is integrally connected with the annular sleeve portion 44, and the top and bottom ends of the front connecting portion 45 have a top opening 452 and a bottom opening 454, respectively. The bottom end of the rear connecting portion 46 is integrally connected with the rear end of the bottom portion 43. The front and rear ends of the gripping portion 47 are integrally connected with the top end of the front connecting portion 45 and the top end of the rear connecting portion 46, respectively. As shown in FIG. 3, the annular sleeve portion 44 of the rear handle 40 is assembled with the annular flange 32 of the housing 32 is such a way that the second guiding convexities 48 and the second guiding concavity 49 are inserted into the first guiding concavities 36 and the first guiding convexity 38, respectively. By this way, the rear handle 40 is rotatable relative to the housing 30.

Further, as shown in FIGS. 2 and 3 a motor switch 16 is provided to the gripping portion 47 of the rear handle 40 and electrically connected with (e.g., electric wires) the aforesaid motor, such that the motor is started by operating the motor switch 16. The aforementioned electrical connection way is conventional, so it will not go into details here. Two batteries 18 are disposed within the bottom portion 43 of the rear handle 40 for providing power to the motor.

As shown in FIGS. 2 and 3, the positioning unit 50 is located in front of the motor switch 16 and provided with a push button 51, a positioning block 54, a link rod 57, and an electric member 58 (here, a compression spring is taken as an example). The push button 51 has a pivot portion 52 pivoted to the top end of the front portion 45 of the rear handle 40, and a pushed portion 53 exposed to the top surface of the rear handle 40 through the top opening 452 (as shown in FIG. 4). By this way, the push button 51 is pivotable relative to the rear handle 40 when the pushed portion 53 is pushed by an external force. The positioning block 54 is disposed in the rear handle 54 and adjacent to the annular flange 32 of the housing 30 through the bottom opening 454. A pair of lugs 55 are provided at the top surface of the positioning block 54, and a support portion 56 is provided at the rear surface of the positioning block 54. The link rod 57 is disposed in the rear handle 54, and has a top end eccentrically pivoted to the pivot portion 52 of the push button 51 by using a first shaft 59 and a bottom end pivoted to the lugs 52 of the positioning block 54 by using a second shaft 60. By this way, the link rod 57 is driven by the push button 51 to move the positioning block 54. The elastic member 58 is disposed in the rear handle 40 and has a top end abutted against an obstruction wall 456 of the rear handle 40 for support and a bottom end abutted against the support portion 56 of the positioning block 54, such that the elastic member 58 provides an elastic force to push the positioning block 54 towards the annular flange 32 of the housing 30.

When the angle of the rear handle 40 is adjusted, the push button 51 is pushed to an unlock position P2 where the positioning block 54 is driven by the push button 51 through the link rod 57 to be disengaged from the positioning recesses 34, as shown in FIG. 4, such that the rear handle 40 is rotatable to adjust operating angle. Once the rear handle 40 is adjusted to a suitable angle, the force applied to the push button 51 is released for enabling the positioning block 54 to be engaged with one of the positioning recesses 34 by the force of the elastic member 58. Further, the push button 51 is driven by the positioning block 54 through the link rod 57 to move back to a lock position P1 as shown in FIG. 3. At this time, the rear handle 40 is positioned.

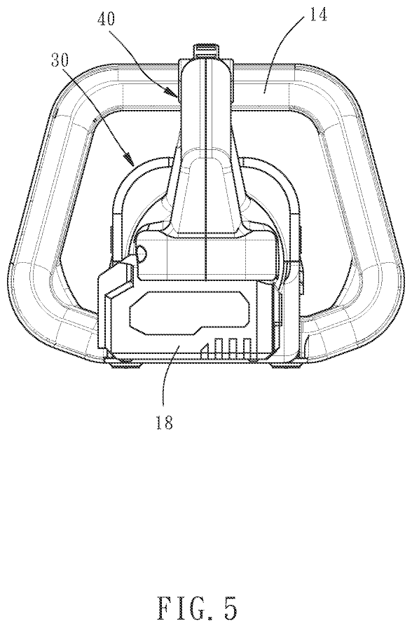

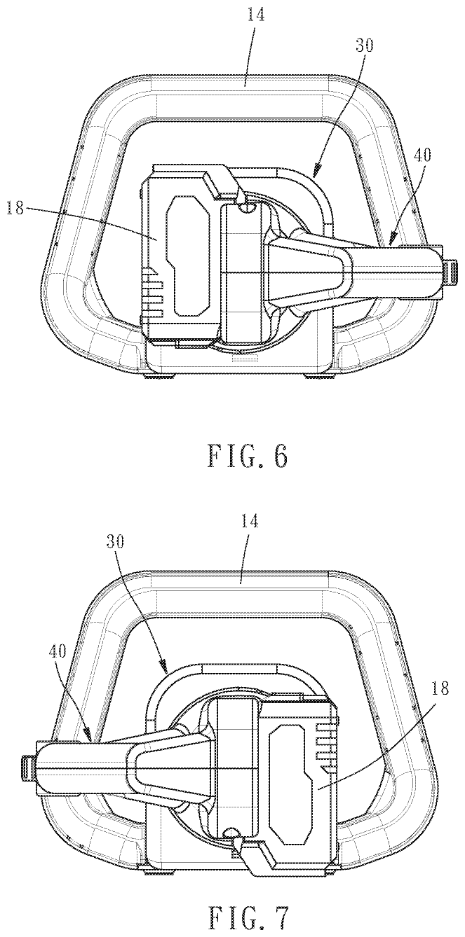

In actual operation, the user (a right-handed person is taken as an example) uses the left hand to hold the front handle 14, and then uses the right hand to hold the gripping portion 47 of the rear handle 40, and then uses the index finger to operate the moto switch 16, such that the motor is started to drive the blades 12 for trimming jobs. When adjusting the angle of the rear handle 40, the user uses the thumb to push the push button 51 to the unlock position P2 as shown in FIG. 4. Thereafter, the angle of the rear handle 40 can be adjustable according to actual needs. For example, FIG. 5 shows that the rear handle 40 is positioned at 0 degree. FIG. 6 shows that the rear handle 40 is rotated 90 degrees in a clockwise direction. FIG. 7 shows that the rear handle 40 is rotated 90 degrees in a counterclockwise direction. Once the rear handle 40 is adjusted to a suitable angle, the user releases the force applied to the push button 51 to complete the positioning of the rear handle 40. In other words, the user uses one hand to keep the electrical hedge trimmer 10 in balance and uses the other hand to control operation of the motor and adjust the angle of the rear handle 40. This not only can help the user to change the state of operation quickly, but also can allow the user to operate the rear handle 40 at an ergonomic angle, thereby achieving effects of enhancing work efficiency, reducing fatigue and increasing comfort.

What is claimed is:

1. A rotary type gripping device for an electrically hedge trimmer, comprising:
a housing having an annular flange at a rear end thereof and a plurality of positioning recesses provided at the annular flange;
a rear handle rotatably disposed to the annular flange of the housing; and
an positioning unit including a push button pivoted to the rear handle and pivotable relative to the rear handle between a lock position and an unlock position, a positioning block disposed in the rear handle and adjacent to the annular flange of the housing, a link rod disposed in the rear handle and having one end thereof eccentrically pivoted to the push button and the other end thereof pivoted to the positioning block, such that the link rod is driven by the push button to move the positioning block, and an elastic member disposed in the rear handle and pushing the positioning block towards the annular flange of the housing, wherein when the push button is located at the lock position, the positioning block is engaged with one of the positioning recesses of the housing, such that the rear handle is nonrotatable relative to the housing, and when the push button is located at the unlock position, the positioning block is disengaged from the positioning recesses of the housing, such that the rear handle is rotatable relative to the housing.

2. The rotary type gripping device as claimed in claim 1, wherein the positioning recesses are arranged in an equally-spaced manner relative to a center of the annular flange.

3. The rotary type gripping device as claimed in claim 1, wherein the push button has a pushed portion exposed to a top surface of the rear handle.

4. The rotary type gripping device as claimed in claim 1, wherein an outer surface of the annular flange of the housing has two first guiding concavities and a first guiding convexity abutted between the first guiding concavities; an inner surface of a front end of the rear handle has two second guiding convexities and a second guiding concavity abutted between the second guiding convexities; the second guiding convexities of the rear handle are inserted into the first guiding concavities of the annular flange of the housing, and the second guiding concavity of the rear handle is inserted into the first guiding convexity of the annular flange of the housing.

5. The rotary type gripping device as claimed in claim 1, wherein one end of the elastic member is abutted against an obstruction wall of the rear handle, and the other end of the elastic member is abutted against a support portion of the positioning block.

6. The rotary type gripping device as claimed in claim 1, further comprising a motor switch provided to the rear handle and located behind the positioning unit.
